(19) United States
(12) Patent Application Publication
(10) Pub. No.: US 2016/0070397 A1
(43) Pub. Date: Mar. 10, 2016

(54) TOUCH PANEL MODULE

(71) Applicant: CANDO CORPORATION, Hsinchu (TW)

(72) Inventors: KAO-HUI SU, Hsinchu County (TW); CHI-KUANG LAI, Taoyuan County (TW); Yih-Jer LIN, Kaohsiung City (TW); CHUN-HUA CHANG, Miaoli County (TW)

(21) Appl. No.: 14/708,587

(22) Filed: May 11, 2015

(30) Foreign Application Priority Data
Sep. 4, 2014 (TW) 103215815

(51) Int. Cl. G06F 3/041

(52) U.S. Cl. CPC G06F 3/0412

(57) ABSTRACT

A touch panel module includes a display screen, a touch sensing member, and a cover lens. The display screen has a color filter layer provided on an outermost side thereof. The touch sensing member has a substrate and a touch sensing circuit, wherein the substrate is made of a transparent material. The touch sensing circuit is provided on the substrate to accept touching and generate corresponding electric signals. In addition, the substrate of the touch sensing member is adhered on the color filter layer of the display screen with an adhesive, which is made of a transparent adhesive material. The cover lens is made of a transparent hard material, and is installed on the touch sensing circuit.

### CROSS-REFERENCE TO RELATED APPLICATION

This application claims the priority benefit of Taiwan application Ser. No. 103215815, filed on Sep. 4, 2014. The entirety of the above-mentioned patent application is hereby incorporated by reference herein and made a part of this specification.

### BACKGROUND OF THE INVENTION

1. Technical Field

The present invention relates generally to the structure of panels, and more particularly to a touch panel module.

2. Description of Related Art

Touch display panels are widely used in a variety of electronic devices as input interfaces nowadays. Among the conventional types, on-cell touch panels are usually manufactured with photolithography method, wherein the touch sensing circuit in an on-cell touch panel can be formed on the color filter substrate of the display screen in this way.

However, if the circuit is damaged or electrical connection fails during the photolithography process due to any reason, the color filter substrate or even the whole display screen has to be abandoned. In other words, such manufacturing process may cause unnecessary material waste, and therefore increases the cost.

In light of this, there is still room for improvement in manufacturing a touch panel module.

### BRIEF SUMMARY OF THE INVENTION

In view of the above, the primary objective of the present invention is to provide a touch panel module, of which the color filter substrate or the whole display screen are not necessary to be abandoned even when something goes wrong during the manufacturing process to damage the touch sensing circuit, fail electrical connections, or lead to poor appearance. Whereby, materials can be prevented from being wasted, and the manufacturing cost can be effectively reduced as a result.

The present invention provides a touch panel module which includes a display screen, a touch sensing member, and a cover lens. The display screen includes a color filter layer. The touch sensing member has a substrate and a touch sensing circuit, wherein the substrate is made of a transparent material; the touch sensing circuit is provided on the substrate; the touch sensing member is adhered on the color filter layer of the display screen with an adhesive, which is made of a transparent adhesive material. The cover lens is made of a transparent hard material, wherein the cover lens is installed on the touch sensing circuit.

According to an exemplary embodiment of the present invention, the substrate is made of a flexible material.

According to an exemplary embodiment of the present invention, the substrate is made of polymide, polyethylene terephthalate, or polymethylmethacrylate.

According to an exemplary embodiment of the present invention, the touch sensing circuit includes a touch sensing electrode layer and a pad; the touch sensing electrode layer senses touching and accordingly generates electric signals; the pad is electrically connected to the touch sensing electrode layer to output the electric signals generated by the touch sensing electrode layer; the cover lens is coated with a light tight shielding ink on a surface facing the touch sensing circuit, and the shielding ink shields the pad.

According to an exemplary embodiment of the present invention, the cover lens is made of glass, plastic, or sapphire.

According to an exemplary embodiment of the present invention, the adhesive is made of optical acrylic resin.

With the aforementioned design, even if the touch sensing circuit is damaged, any electrical connections fails, or appearance is made poor during the manufacturing process, the malfunctioned touch sensing circuit can be simply removed without abandoning the color filter substrate or the whole display screen. Whereby, materials can be prevented from being wasted, and the manufacturing cost can be therefore effectively reduced.

Several exemplary embodiments accompanied with figures are described in detail below to further describe the invention in details.

### BRIEF DESCRIPTION OF THE SEVERAL VIEWS OF THE DRAWINGS

The present invention will be best understood by referring to the following detailed description of some illustrative exemplary embodiments in conjunction with the accompanying drawings, in which

FIG. 1 is a perspective view of a preferred embodiment of the present invention;

FIG. 2 is a schematic diagram of the preferred embodiment of the present invention; and

FIG. 3 to FIG. 6 are schematic diagrams respectively showing each step of the manufacturing process.

### DETAILED DESCRIPTION OF THE INVENTION

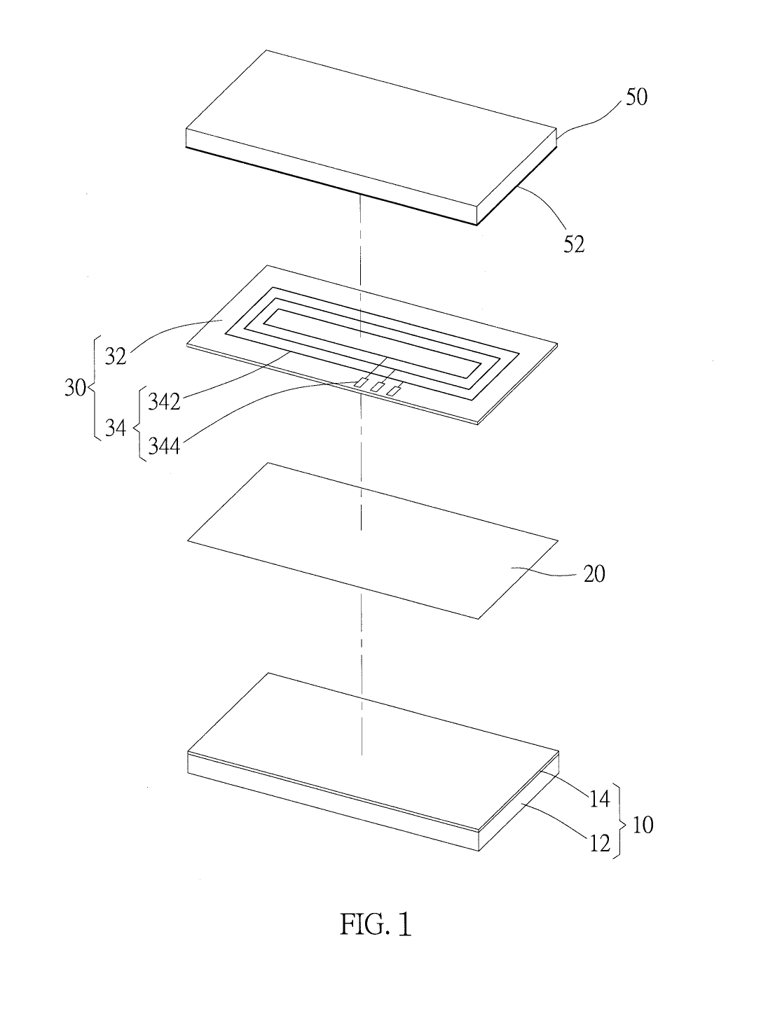

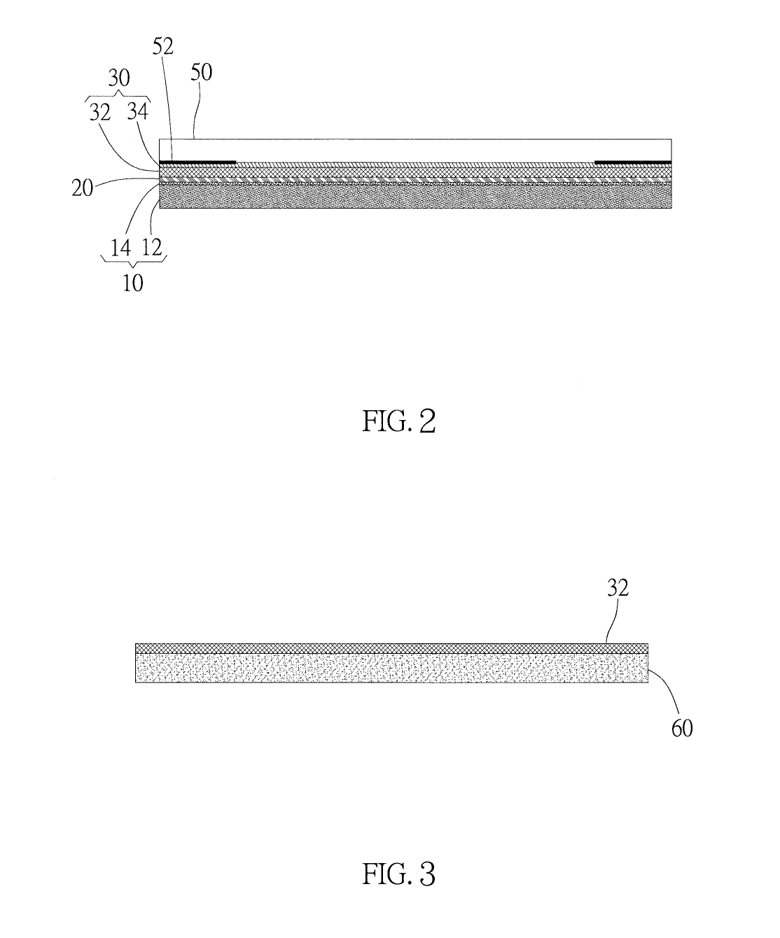

As shown in FIG. 1 and FIG. 2, a touch panel module of the preferred embodiment of the present invention includes a display screen 10, a touch sensing member 30, and a cover lens 50.

The display screen 10 receives electric signals and renders images accordingly. In the preferred embodiment, the display screen 10 includes a panel 12 and a color filter layer 14 provided at an outermost side thereof, wherein the panel 12 omits light rays needed for rendering images. The panel 12 mainly includes a light source, a light guide plate, liquid crystals, and other components; however, the panel 12 herein is not described in detail because it is conventional and well-known in the art. The color filter layer 14 is provided on the panel 12 to adjust colors of the passing-through light rays.

The touch sensing member 30 has a substrate 32 and a touch sensing circuit 34, wherein the substrate 32 is made of a transparent material. In the preferred embodiment, the substrate 32 is flexible and is made of Polymide (PI), which is not a limitation of the present invention. Except Polymide, the substrate 32 can also be made of Polyethylene terephthalate (PET), Polymethylmethacrylate (PMMA), or other transparent of flexible materials. The touch sensing circuit 34 is formed on the substrate 32 with photolithography processing, wherein the touch sensing circuit 34 includes a touch sensing electrode layer 342 and a plurality of pads 344 which are electrically connected to the touch sensing electrode layer 342. The touch sensing electrode layer 342 has a plurality of sensing electrodes, each of which senses touch actions and generates corresponding electric signals. The pads 344 is used for connecting other signal buses, such as flexible printing circuit boards (not shown), to output the electric signals. For easy connection with other signal buses, the pads 344 are located around a periphery of the touch sensing electrode layer 342. In addition, the substrate 32 of the touch sensing member 30 is adhered to the color filter layer 14 of the display screen 10 with an adhesive 20, and therefore the touch sensing member 30 is fixedly adhered to the display screen 10. In the preferred embodiment, the adhesive 20 is made of optical acrylic resin, which is also called optical clear adhesive (OCA). However, this is not a limitation of the present invention; other transparent adhesive materials may be chosen too.

The cover lens 50 is made of a transparent hard material, and is installed on the touch sensing circuit 40 to keep dust out and to shield the touch sensing member 30 and the display screen 10 at the same time, whereby such components can be prevented from being damaged by force exerting thereon. In the preferred embodiment, the cover lens 50 is made of sapphire to be scratch-resistant, anti-wear, and anti-corrosion. In practice, the cover lens 50 can, of course, be made of plastic or glass to achieve the same purpose. In addition, the cover lens 50 is coated with one or more layers of light tight shielding ink 52 around a periphery of a surface facing the touch sensing circuit 34. Specifically, when the cover lens 50 is installed on the touch sensing circuit 34, the shielding ink 52 covers the pads 344 to shield a part of circuit structure of the touch sensing circuit 34 for aesthetic purpose.

In short, the touch sensing member 30 is adhered to the color filter layer 14 with the adhesive 20. With such design, if the touch sensing member 30 is damaged, electrical connections fail, or appearance is made poor during the manufacturing process, or even after the assembling process is completed, the malfunctioned touch sensing member 30 can be removed from the color filter layer 14, and the color filter layer 14 or the whole display screen 10 is not necessary to be abandoned. Therefore, the materials can be avoided from being wasted, which effectively reduces the manufacturing cost.

The manufacturing process of the aforementioned structure is illustrated in FIG. 3 to FIG. 6.

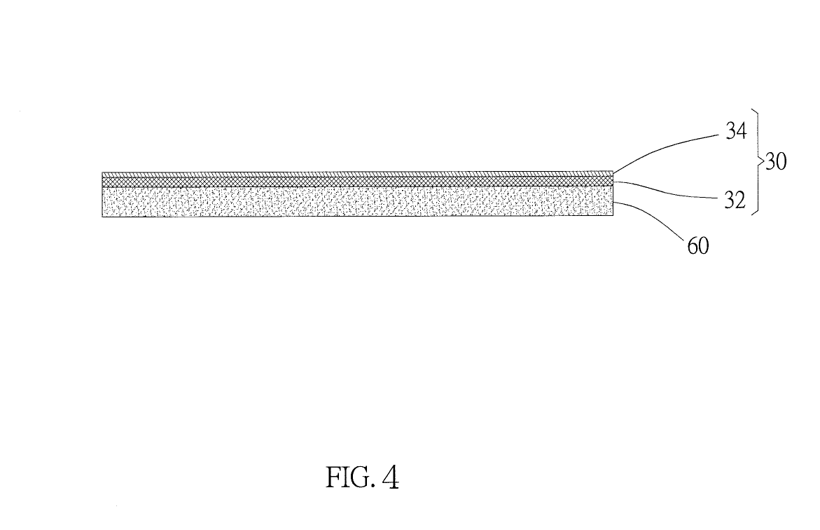

As shown in FIG. 3, a hard supporting plate 60 is provided first, on which a transparent flexible material such as PI, PET, PMMA is coated, and such materials are then solidified to be the substrate 32, wherein a thickness of the substrate 32 is approximately 10 μm; however, the thickness of the substrate is not a limitation of the present invention, and can be thicker or thinner according to the required resistance of the touch panel module. After that, the touch sensing circuit 34 is formed on the substrate 32 with the photolithography process, as shown in FIG. 4, to complete the fixable touch sensing member 30.

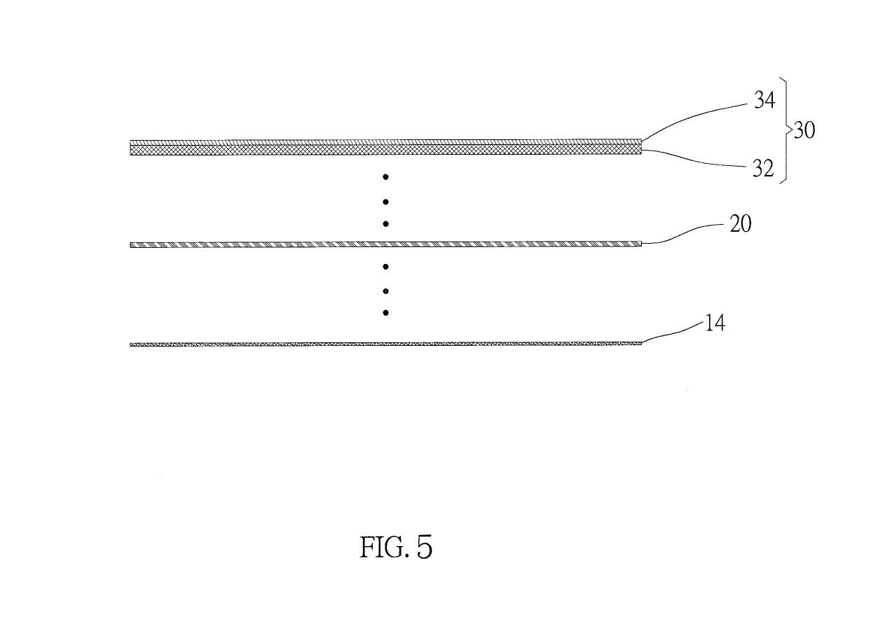

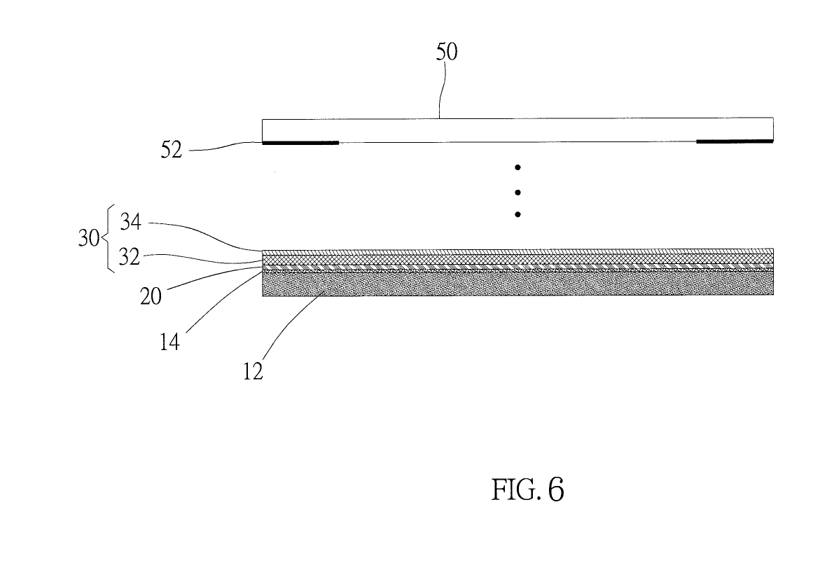

Next, the touch sensing member 30 is removed from the supporting plate 60 to be adhered to the color filter layer 14 with the adhesive 20. In the preferred embodiment, as shown in FIG. 5, the adhesive 20 such as the above mentioned optical acrylic resin is first applied under the substrate 30 of the touch sensing member or on the color filter layer 14. After that, as shown in FIG. 6, the touch sensing member 30 is adhered on the color filter layer 14 with the adhesive 20, and then the color filter layer 14 adhered with the touch sensing member 30 is fixedly installed on the panel 12. In another preferred embodiment, the color filter layer 14 is connected to the panel 12 as the display screen 10 first, and then the touch sensing member 14 is adhered to the color filter layer 14 of the display screen 10 with the adhesive 20. It is worth mentioning that the touch sensing member 30 is flexible, and therefore the touch sensing member 30 can be bent in accordance to a surface of the color filter layer 14 of the display screen 10. In this way, the touch sensing member 30 can be perfectly adhered on the display screen 10, which increases the reliability of the manufacturing process.

Finally, as shown in FIG. 6, the structure illustrated in FIG. 1 (the display screen 10, the touch sensing member 30, and the cover lens 50 are orderly arranged from bottom to top) can be completed by installing the cover lens 50, which has the shielding ink 52 coated around the periphery thereof, on the touch sensing circuit 34.

In summary, the touch sensing circuit 34 is formed on the substrate 32 first, and then the touch sensing member 30 is adhered to the color filter layer 14. Since the touch sensing circuit 34 is not directly formed on the color filter layer 14, even if the touch sensing member 30 is damaged, electrical connections fail, or appearance is made poor during the aforementioned manufacturing process, the malfunctioned touch sensing member 30 can be removed from the color filter layer 14 to proceed the assembling process over again. As a result, the color filter layer 14 is not necessary to be abandoned, and therefore the materials can be avoided from being wasted, which effectively reduces the manufacturing cost as mentioned above.

It must be pointed out that the embodiments described above are only some preferred embodiments of the present invention. All equivalent structures which employ the concepts disclosed in this specification and the appended claims should fall within the scope of the present invention.

What is claimed is:

1. A touch panel module, comprising:
a display screen including a color filter layer;
a touch sensing member having a substrate and a touch sensing circuit, wherein the substrate is made of a transparent material; the touch sensing circuit is provided on the substrate; the touch sensing member is adhered on the color filter layer of the display screen with an adhesive, which is made of a transparent adhesive material; and
a cover lens made of a transparent hard material, wherein the cover lens is installed on the touch sensing circuit.

2. The touch panel module of claim 1, wherein the substrate is made of a flexible material.

3. The touch panel module of claim 1, wherein the substrate is made of polymide, polyethylene terephthalate, or polymethylmethacrylate.

4. The touch panel module of claim 2, wherein the substrate is made of polymide, polyethylene terephthalate, or polymethylmethacrylate.

5. The touch panel module of claim 1, wherein the touch sensing circuit includes a touch sensing electrode layer and a pad; the touch sensing electrode layer senses touching and accordingly generates electric signals; the pad is electrically connected to the touch sensing electrode layer to output the electric signals generated by the touch sensing electrode layer; the cover lens is coated with a light tight shielding ink on a surface facing the touch sensing circuit, and the shielding ink shields the pad.

6. The touch panel module of claim 1, wherein the cover lens is made of glass, plastic, or sapphire.

7. The touch panel module of claim 1, wherein the adhesive is made of optical acrylic resin.

8. A method of making a touch panel module, comprising the steps of:
A. applying a transparent flexible material on a hard supporting plate to form a substrate;
B. forming a touch sensing circuit on the substrate to form a touch sensing member;
C. removing the touch sensing member from the supporting plate, and adhering the touch sensing member to a color filter layer with a transparent adhesive material;
D. installing a cover lens on the touch sensing circuit o form a touch panel module, wherein the cover lens is made of a transparent hard material.

9. The method of claim 8, wherein transparent flexible material in step A is polymide, polyethylene terephthalate, or polymethylmethacrylate.

10. The method of claim 8, wherein the touch sensing circuit includes a touch sensing electrode layer and a pad; the touch sensing electrode layer senses touching and accordingly generates electric signals; the pad is electrically connected to the touch sensing electrode layer to output the electric signals generated by the touch sensing electrode layer; the cover lens is coated with a light tight shielding ink on a surface facing the touch sensing circuit, and when the cover lens is installed on the touch sensing circuit, the shielding ink shields the pad.

11. The method of claim 8, wherein the transparent adhesive material in step C is applied on the substrate first, and then the substrate is adhered to the color filter layer with the transparent adhesive material.

12. The method of claim 8, wherein the transparent adhesive material in step C is applied on the color filter layer first, the substrate is provided on the transparent adhesive material, and then the substrate is adhered to the color filter layer with the transparent adhesive material.

13. The method of claim 8, wherein the transparent adhesive material is optical acrylic resin.

14. The method of claim 8, wherein the color filter layer which provided with the touch sensing member is provided on a panel after step C.

15. The method of claim 8, wherein the cover lens is made of glass, plastic, or sapphire.
